(19) United States
(12) Patent Application Publication
(10) Pub. No.: US 2015/0150745 A1
(43) Pub. Date: Jun. 4, 2015

(54) Set-down Device and Stimulator, also Method for Neurophysiological Stimulation and use of a Stimulator

(71) Applicant: Kresimir STRLEK, (US)

(72) Inventor: Kresimir Strlek, Gormaringen (DE)

(21) Appl. No.: 14/356,726

(22) PCT Filed: Nov. 6, 2012
(86) PCT No.: PCT/DE2012/100338

§ 371 Date: May 7, 2014

(30) Foreign Application Priority Data
Nov. 7, 2011 (DE) 10 2011 055 099.2

(51) Int. Cl. A61H 1/00

(52) U.S. Cl. CPC A61H 1/005

(57) ABSTRACT

A set-down device for setting down on a neurophysiological stimulator for transmitting movements generated by the system, at least comprising a set down side for setting down on the stimulator, and also comprising a transmission side for transmitting the movements received via the set-down side, wherein the transmission side has at least one at least partially projecting stimulation element, which is suitable for transmitting the movements and thus for neurophysiological stimulation. A neurophysiological stimulator for stimulating an object by the transmission of movements generated by the stimulator, at least comprising a movement unit and at least one drive unit for generating the movement, the drive unit being coupled to the movement unit, wherein the drive unit is designed as a tumbling and/or spinning unit and generates a tumbling and/or spinning movement. A method for the neurophysiological stimulation of an object by the transmission of movements generated by a stimulator.

The invention relates to a set-down device to be placed on a neurophysiological stimulation device according to the preamble of claim 1.

The invention further relates to a neurophysiological stimulation device for stimulating an object according to the preamble of claims 7 and 8.

The invention also relates to a method according to the preamble of claim 13.

The invention additionally relates to a use of a neurophysiological stimulation device according to claim 15.

Stimulation devices for stimulating living beings, particularly humans, are generally known. In such devices, the bodily functions are stimulated by movements of the stimulation device that are transmitted to the person, which in turn exerts positive effects on bodily functions, the musculoskeletal system, musculature, bone structure and human well-being.

Document DE 20 2006 009 373 U1 describes a mechanism for stimulating a skeleton, with an oscillating platform which is mounted such that it can oscillate in an at least approximately horizontal plane, all of the points on the platform defining a closed circumferential path. In this way, forces are generated which have an effect on bone structure and on the musculoskeletal system in general. The forces are generated by an approximately horizontal oscillation in the form of a closed circular or elliptical path. In the process, however, the movement is transmitted directly to the person without any additional stimulation and/or enhancement of the movement and its effect on the human body.

It is an object of the present invention to provide a possibility for transmitting the movement of a stimulation device to an object in a better way, in particular in an enhanced way. Furthermore, it is an object of the present invention to produce a stimulation device for the improved transmission of movement and thus for improved stimulation, and to provide a method and a use thereof.

These and further problems are solved on the basis of a set-down device according to claim 1, a stimulation device according to claim 5, a method according to claim 9 and a use according to claim 11 in conjunction with, their feat tires. Advantageous developments of the invention are indicated in the dependent claims or are indicated below in connection with the description of the drawings.

The invention includes the technical teaching that a set-down device, which is intended to be placed on a neurophysiological stimulation device, in particular on a moving plate, in order to transmit movements generated by the system and which at least comprises a support side for supporting the set-down device on the stimulation device and a transmission side for transmitting and/or relaying the movements received by the support side, is designed as a passive set-down device configured in the form of a mat or plate, the transmission side having at least one at least partly protruding stimulation element that is well-suited to transmit the movements and is thus weld-suited for neurophysiological stimulation. Neurophysiological stimulation is generally understood within the scope of the present patent application to refer to a stimulation of the bodily functions of a living being such as a human or animal. A detailed description of this stimulation follows. The specification ‘human’ is preferably used here, although the present invention can equally be used on an animal, such as a dog. Here the movement is generated in the form of an oscillation movement, preferably in the form of a swiveling and/or wobbling movement, and is transmitted to the living being. A detailed description of the oscillation likewise follows.

According to the invention, the set-down device has a support side and a transmission side. If is advantageous when each of the two sides of the set-down device is configured in one part, but in other embodiments they are configured in multiple parts. Thus the set-down device is configured in one part or in multiple parts. In order to simplify production of the set-down device, it is produced in multiple parts. In a preferred embodiment, the set-down device is embodied as a mat-like or cover-like set-down device, i.e. as a support mat or support cover. Accordingly, the support side and the transmission side are preferentially configured as opposite sides. One embodiment provides that the support and transmission sides be configured in one part, i.e. integrated with each other. In other embodiments, these two sides are configured separately from each other, i.e. in multiple parts, and are connected to each other, for example, only in the edge region, such as by stitching, welding and/or adhering. The set-down device comprises the plate-like base body. This body is preferably cuboid in shape. In one embodiment, the base body is configured as an aluminum plate, for example, with anodized aluminum. The support side and the transmission side are distanced from each other on opposite sides, especially the large sides. Between them, the base body in one embodiment is solid, i.e. without hollow cavities or the like. In another embodiment, the set-down device is configured with at least one hollow cavity, preferably with a plurality of hollow cavities. In one embodiment, said hollow cavities are filled with oscillating mass. In one embodiment, the oscillating mass is formed as crystals, quartzes or the like. In another embodiment, other granular material is formed. Preferably, the oscillating mass is formed of solid materials. In other embodiments, the oscillating mass is formed as a liquid material. In still other embodiments, the oscillating mass is configured differently in different hollow cavities; for instance, differently granulated, in different amounts, in different states of aggregation and so forth. In a preferred embodiment, all of the hollow chambers are configured with the same oscillating mass. The hollow chambers are configured, for example, as blind holes in the base body and are closed with a cover plate. The hollow cavities are preferably not completely filled but are instead only partially filled, e.g. 10, 20, 30, 40, 50, 60, 70, 80, 90 or another percentage by volume. The chambers are preferably cuboid. The set-down device itself is not powered and thus has a passive design.

One embodiment provides that the at least one stimulation element be formed of a substantially inflexible material. Said material can be a thermosetting plastic, a wood, metal, steel, a quartz or the like.

The support side preferably serves to support the set-down device on the stimulation device, Preferably, the support-side is planar or level in design. Likewise preferably, the transmission side serves to transmit and/or relay the movements received by the support side to the person. For the transmission, the person is preferably arranged on the transmission side, for example, standing, kneeling and/or lying or merely keeping the respective body parts that are preferably to be stimulated propped on the transmission side. Accordingly, the transmission side preferably functions as the upper side of the set-down device, and the support side functions as the lower side. Suitable material for the set-down device and its side preferably include a robust, durable material that is advantageously washable, tear-resistant, water-resistant and/or rust-proof, e.g. polyester, cotton, especially laminated and/or waterproofed cotton, material compounds, rayon, etc. Preferably, at least the support side comprises a rubber coating in order to prevent the set-down device from sliding away from the stimulating device. The material is preferably configured as an inflexible material so that no or only insignificant deformation occurs under loads up to 200 kg.

According to the invention, the transmission side comprises at least one projecting or protruding stimulation element. This at least one stimulation element ensures that the movements of the stimulation device are transmitted to the person for neurophysiological stimulation. It is preferred that more than one stimulation element, such as two, three or four stimulation elements, be provided. It is also preferred that a multitude of stimulation elements be provided on the transmission side. Preferentially, the stimulation elements are attached to the transmission side, for example by adhering, welding and/or stitching.

In one embodiment, the stimulation elements are attached individually to the transmission side; in other embodiments, multiple stimulation elements are attached to the transmission side, i.e. in groups. Multiple stimulation elements are connected together by a connection part in one embodiment. Here the stimulation elements are detachable connected to the connection part in one embodiment and non-detachably connected to it in another embodiment. Said connection part can be configured as a connection plate, for example. The stimulation elements are attached to the support side via the connection part. In one embodiment, a plurality of stimulation elements is attached to the support side by a plurality of connection parts.

The stimulation elements preferentially project from the transmission side at a height of up to 30 mm, preferably up to 20 mm and more preferably of up to 10 mm and most preferably of up to 5 mm. In this regard, it is provided in one embodiment that the stimulation elements are configured as stimulation elements which taper in the direction away from the transmission side. The tapering stimulation elements preferably have a shape selected from the group that includes cone, pyramid, cylinder, truncated cone, truncated pyramid etc. Accordingly, these shapes are formed narrower or smaller at the end oriented away from the transmission side than at the end attached to the transmission side. Shapes which are not angular, which are thus round, for example, are preferably selected for the transmission elements, such as a truncated cone. For instance, the width or diameter of a truncated cone measures up to 30 mm on its lower end oriented toward the transmission side, preferably up to 20 mm and more preferably up to 10 mm and most preferably up to 50 mm. At its opposite end, the width of a truncated cone measures e.g. up to 10 mm, preferably up to 5 mm and more preferably up to 2.5 mm and most preferably up to 1.5 mm. A distance between two upper regions of two adjacent truncated cones corresponds to the width of one truncated cone, for example. Preferentially, the stimulation elements that are employed are each configured uniformly. One embodiment provides that the stimulation elements are embodied as nubs.

Advantageously, the stimulation elements can be loaded with a weight of up to 200 kg or with a force of up to 2 kN without undergoing plastic or reversible deformation. In this way, it is ensured that the set-down device and its stimulation elements on the upper side will withstand the load of a person arranged on the set-down device without being damaged. In one embodiment, the stimulation elements are elastically deferrable under load, a deformation path of this deformation being as small as possible. Suitable for this purpose are materials preferably selected from the group comprising: plastic, preferably hard plastic, metal, wood, ceramics etc. In a preferred embodiment, the stimulation elements consist of a medical-grade plastic such as polyethylene, polystyrene polyvinylchloride, polypropylene and/or ethylene vinyl acetate. Stones, precious stones, crystals and the like, especially tourmaline, can be used as further suitable materials. For example, a granulate is used during production which cam contain plastic, stone and/or ceramics. In one embodiment, the granulate is liquefied and injected into a corresponding mold.

The support side is not directly connected to a drive unit. Thus the set-down device is configured as a passive set-down device. In one embodiment, the set-down device rests on a plate of a stimulation device. At the same time, the stimulation device comprises a movement unit with a support surface. Said movement unit is moved by an appropriate drive. The unit moved the support surface. The passive supporting surface rests on the support surface and moves in the support plane in a manner not relative to the support surface. The set-down device is thus arranged stationary with respect to the support surface and so it is included in the oscillation movement of the support surface. The oscillating mass of the set-down device functions as an oscillation enhancer, as do the stimulation elements.

In a further embodiment, it is provided that a stimulation element or multiple stimulation elements comprise functional units, a functional unit contains, for example, at least one signal generator. The signal generator is configured in one embodiment as an acoustic signal generator. In another embodiment, the signal generator is configured as an optical signal generator. Other embodiments provide a heat generator, such as an infrared unit. Alternatively, at least one of the functional units is configured as a movement unit, functional units of this type additionally serving to provide further stimulation. In one embodiment, a functional unit is configured as an illuminant. In one embodiment, the functional unit is activated by a control unit that is coupled with it. Different illuminations are achieved in this way, such as with respect to colored lighting.

It is provided in one embodiment of the claimed set-down device that multiple stimulation elements arranged in at least one structural unit are provided in order to optimize the transmission. Advantageously, more than one structural unit, i.e. two, three or four structural units, are provided, A preferred embodiment includes the arrangement of the stimulation, elements in a plurality or in a multitude of structural units. A structural unit preferably comprises a plurality of stimulation elements, preferably at least three stimulation elements, more preferably a multitude of stimulation elements. Said stimulation elements are preferentially arranged in a geometric pattern and/or arrangement in the structural unit. The structural units preferably have a round, oval, honeycombed or angular, especially rectangular, shape. In one embodiment, the stimulation elements are arranged concentrically in the shape of a structural unit, for example, in concentric circles or rectangles. In other embodiments, this arrangement is in a winding or spiraling shape. In one embodiment, the stimulation elements are spaced apart from each other; that is, they are configured as separate stimulation elements. The spaced-apart stimulation elements in one embodiment are connected to each other via a common connecting part, such as structural units. In one embodiment, the structural units are arranged at a distance from each other. In a further embodiment, the structural units can be detachably and non-detachably connected to other components.

One embodiment of the structural units provides that the stimulation elements of a structural unit are connected to one another. This connection is made, for example, by means of a common connecting part, such as a plate-shaped undersurface, which ensures the connection to the transmission side while also connecting the stimulation elements together. In one embodiment, the thickness of the undersurface is as much as 20 mm, preferably as much as 10 mm and more preferably as much as 5 mm. The size of an undersurface, i.e. preferably the diameter of an undersurface, corresponds to the size of a structural unit or at least to the sum of all of the stimulation elements combined into the structural unit. In a round structural unit, the diameter lies e.g. between 10 mm and 50 mm, preferably between 20 mm and 40 mm and more preferably between 25 mm and 35 mm, The material in the undersurface in one embodiment is configured equivalently to the material in the stimulation elements. Accordingly, one embodiment provides that a structural unit or the structural elements of a structural unit are configured in one part, i.e. integrated into each other. In the stimulation elements that are arranged in a structural unit, the load capacity of a structural unit is advantageously greater than that of an individual stimulation element.

In yet another embodiment of the set-down device according to the invention, it is provided that multiple structural units are arranged in a transmission pattern. Said transmission pattern is preferentially a geometric pattern, such as a matrix, a grid, a random arrangement or the like. In this way, the structural units are preferably each arranged at a regular, more preferably equal, distance from each other. The distance between two structural units of a transmission pattern is, for example, between 5 mm and 60 mm, preferably between 10 mm and 50 mm, more preferably between 20 mm and 40 mm and most preferably approximately 30 mm. It is advantageous when the transmission pattern is configured such that the stimulation and transmission of movements occurs over the largest area possible.

Multiple structural units are connected to each other, for example, by means of a flexible element such as a mat or the like. The set-down device is advantageously embodied as a mat. The mat is preferably configured as an anti-slip mat on one side. The mat is preferably formed as an elastic and/or viscoelastic element. The mat can also be configured as a mattress or the like. The mat deforms commensurately under load. In this way, it is ensured that optimal contact with the user is established.

If is provided in one embodiment that the set-down device comprises at least one hollow cavity, an oscillating mass being provided in at least one hollow cavity. The oscillating mass is particularly a granular or granulate-like oscillating mass consisting e.g. of a granulate. The granulate is a quartz granulate, for example.

The invention also relates to a stimulation device for stimulating an object by the transmission of movements generated by the stimulation device, especially a movement mechanism for stimulating the therapeutic functions of a living being that occur naturally in the body, at least comprising a movement unit, which is configured to interact with the set-down device and which has a support surface by means of which the generated movements are transmitted to the objects adjacent to the movement unit, and comprising at least one drive unit coupled to the movement unit to generate the movement, said drive unit rotating the movement unit eccentrically when in operation, and the movement unit resting on at least one support element when at rest and lifting from the support element at least temporarily during operation as a result of rotation caused by the drive unit, and so a three-dimensional wobbling and/or sniveling movement is produced. The movement unit is thus designed to interact with the set-down device. The wobbling and/or swiveling movement is achieved such that, if a liquid is provided in a container located on the movement unit, a vortex or eddy is created in the liquid during operation.

Furthermore, the invention relates to a neurophysiological stimulation device for stimulating an object by the transmission of movements generated by the stimulation device, especially a movement mechanism for stimulating the therapeutic functions of a living being that occur naturally in the body, at least comprising a movement unit, which has a support surface by means of which the generated movements are transmitted to the objects adjacent to the movement unit, and comprising at least one drive unit coupled to the movement unit to generate the movement, wherein it is provided that the drive unit is configured as a wobbling and/or swiveling unit which generates a wobbling and/or swiveling movement, a receptacle or support being provided for a set-down device described above. The generation of the wobbling and/or swiveling movement can be recognized, for instance, by the fact that, when a container with a liquid is placed on the movement unit, an eddy is created in the liquid during operation.

According to the invention, the movement unit is embodied as a movement plate. An object or a user, such as a human or an animal, is positioned on the movement plate in order to transmit the movement of the movement unit to said object. The movement unit is preferably configured in one piece. The movement unit preferably further comprises a support surface. In accordance with the one-piece embodiment, of the movement unit, the support surface is executed in one piece, i.e. as a continuous support surface, in particular as a planar or level support surface. The support surface, which is also configured as a support plate, is preferably constructed from a rigid, inflexible material, e.g. from wood, plastic and the like. The respective object is positioned on the support surface. The objects are thus adjacent to the movement unit. Furthermore, a drive unit is provided which is coupled to the movement unit and thus moves it or generates a movement. This movement is transmitted to the person on the support surface of the movement unit. In a preferred embodiment, a set-down device as described above is arranged on the support surface in order to increase the transmitted movement and the effect of the movement on the person. In this case, the set-down device contacts the support surface with its contact side, for example, by being loosely laid on or attached to it. The transmission side is oriented toward the person positioned on the support surface so that the person is arranged directly on the transmission side. The stimulation elements of the set-down device additionally stimulate the human body and thus increase the effect of the movement, of the movement unit. In particular, the oscillating mass is provided. Said mass brings about an additional increase in the effect.

Advantageously, the drive unit is configured as a wobbling and/or swiveling unit. Said drive unit thus generates a wobbling and/or sniveling movement, which transmits neurophysiological stimulation to the person. The wobbling and/or swiveling movement is a movement in which the points that, are moved define an open, i.e., not closed, path. For instance, a clockwise or counterclockwise open circular path is described. In the sense of the present invention, a circular path is also understood to include an elliptical path or any other shape of path that lies in a plane of oscillation or movement. In other words, the open circular movement occurs in the clockwise direction or counter to the clockwise direction. Preferentially, the direction of the circular movement can be controlled and selected. Also advantageous is that it is possible to switch the direction of rotation. In this way, the wobbling and/or sniveling movement can be adapted according to the location of the stimulation device in the northern or southern hemisphere. The wobbling movement is thus configured as a circular path, elliptical path or the like which, in addition to the movement in the plane, also includes a component running transversely to the plane. The wobbling and/or swiveling movement can be verified using a container with liquid. This is placed on the support surface and, when operational, an eddy forms in the liquid. This verification can be easily carried out using a water-filled water glass, for example.

An eddy produced by the rotary motion (in a water glass, for instance) symbolizes a helix of human DNA (deoxyribonucleic acid). Preferentially, the DNA structure is reproduced or emulated by the eddy which is produced. Accordingly, the eddy preferably rotates clockwise. The movement occurs cut of a horizontal plane, i.e. not as a horizontal oscillation. The path defined by a point after a revolution or several revolutions is thus not closed. In the wobbling and/or swiveling movement, it is preferable to forgo a separate lifting movement of an actuator; in other words, the one-part movement unit that is moved by the drive unit does not perform a lifting movement via a corresponding actuator. Instead, a rotary drive is provided. The rotary drive rotates an eccentrically situated shaft or an eccentric pin of the support surface or support plate. A lifting movement of the pin or shaft does not occur. Support elements that, are adjacent to the support plate are provided on the edge of the support surface or support plate. When the support plate rotates alongside the support elements, contact occurs between the support plate and the support elements, and as a result the support plate oscillates toward the circular path formed by the rotary drive. In this way, a three-dimensional circular path or open circular path, i.e. the wobbling and/or swiveling movement, is realized. In one embodiment, the support elements are located at different distances from the edge or from a surface of the support plate, and so the wobbling movement can be adjusted in this way.

In one embodiment, the drive unit preferably produces a three-dimensional oscillation with a frequency of 50-100 Hz, preferably 55-90 Hz, more preferably 60-80 Hz and most preferably 65-75 Hz, especially with a Schumann frequency. The oscillation generated is preferably not sinusoidal but has different harmonics. An advantageous embodiment provides that the generated frequency is a Schumann frequency. The term Schuman frequency is understood to be a resonant frequency of the human body at which the body itself begins to resonate. In so doing, the oscillations not only penetrate into the body, but are also enhanced, whereby a stationary oscillation is formed in the body.

In one embodiment of the claimed neurophysiological stimulation device, it is provided that the drive unit is configured as an eccentric drive unit. Advantageously, said eccentric drive unit comprises an eccentric pin that is coupled with an actuator, which in turn brings about the wobbling and/or swiveling movement without thereby creating a lifting movement, A further embodiment provides that the drive unit is arranged in a cup-like housing that is closed by the movement unit, which functions as a lid. The stimulation device preferably comprises another electricity supply. In this respect, one embodiment of the stimulation device provides that it is configured as a mobile unit. Preferentially, a mobile stimulation device comprises a power supply in the form of a battery or the like. The movement unit is mounted by means of a mount that is designed for the movement unit. Appropriate degrees of freedom, for a wobbling movement should also be included. Thus the wobbling movement requires a mount with three degrees of freedom.

The wobbling movement is preferably realized as follows. The movement unit is connected eccentrically to a drive, which causes the movement unit to rotate eccentrically. The drive itself comprises an actuator which is coupled with an eccentric pin via a toothed belt. The eccentric unit is driven around the eccentric pin. In the resting state, i.e. when the actuator is not actuated, the moving unit is supported on supports. Accordingly, the moving unit is mounted on the supports or support elements. Advantageously, at least two supports or support elements are provided, preferably a plurality of columns. The columns are preferably spaced apart from each other and distributed along one edge of the moving plate. In order for the elements to be mounted on the supports, said supports are preferably firmly attached to a base plate at one end. At the end that faces the moving unit, the supports have an elastic or deformable end piece, for example in the form of a vibration damper. The supports are configured at least partly in different lengths. In one embodiment, the supports are adjustable in length and height. Further, the supports are designed, for example, to be tilted or inclined differently. The height, length and/or inclination of the supports can advantageously be actively adjusted or controlled by means of a corresponding controller. For example, the inclination of the supports is adjustable both before and during operation of the stimulation device. If the actuator is then actuated and an eccentric rotational motion is implemented, then the moving unit begins to vibrate. That is, the moving unit is no longer in contact with all supports at the same time, but is set into three-dimensional rotation as a result of the different support lengths, the elasticity of the rubber elements and the eccentric rotation, so that a wobbling motion is realized. The wobble can be adjusted in particular by the length of the supports. Due to the different inclinations of the supports, the motion, unit, also begins to vibrate.

Advantageously, the rotation and wobbling movement will be superimposed upon each other during the movement.

In a further embodiment of the invention, a height adjustment mechanism is provided. The height adjustment mechanism is coupled to the movement unit and is fixed to the base plate. Using the height adjustment mechanism, the movement-unit can be arranged at different heights relative to the bottom plate. In this way, a wobbling movement can be realized in different heights. The height adjustment mechanism can have any desired configuration, e.g. hydraulic or pneumatic, mechanic and/or electric. In particular, the movement unit is moved relative to the base plate. In other embodiments, the drive components and/or the supports can be adjusted accordingly. Preferably, a height adjustment mechanism is provided under the bottom plate. The height of the stimulation device can thereby be adjusted in a simple manner. The height adjustment mechanism preferably comprises a detent which locks the bottom plate in a predetermined height. Safety button to prevent accidental release, etc.

In yet another embodiment, the stimulation device comprises a control device, by means of which frequencies and/or other functions can be controlled. In one embodiment, the controller comprises a frequency regulator. This makes it possible to adjust the frequency of the base plate. In a further embodiment, the controller comprises an optical control and/or acoustic control, by means of which the corresponding functional units are controlled. In still another embodiment, the controller includes a timer or the like. Other functional units, such as acoustic and/or optical signal transmitters, are installed on the stimulation device. For example, the control unit also comprises a computer unit with computer programs and/or computer program products for running various programs, for instance in the form of individual training units.

Accordingly, one embodiment provides that the movement unit is set into circular or planar motion by the eccentric drive unit during operation, and support elements are provided on the edge of the movement unit or she support surface, which alternatingly contact and do not contact the movement unit during operation so that, as a result, the circular motion has a further direction of movement transversely to a circular path and the three-dimensional oscillation is realized in this way. The open circular path is thus created; in other words, a circular path or planar path which, after completing a complete 360° rotation about the rotational axis, is not located in the starting position before the rotation but instead at least one point on the movement unit assumes a different position in at least one dimension.

The invention also relates to a method for transmitting an oscillation to an object by means of a stimulation device, as described above, or for neurophysiologically stimulating an object by the transmission of movements generated by the stimulation device described above, comprising the steps of generating a movement and transmitting said movement to the object, the movement being generated as a swiveling and/or wobbling movement and being enhanced as it is transmitted. In this way, the transmission of the movement in a preferred embodiment is enhanced by a claimed support mechanism that is described above. Within the framework of the present patent application, enhancement is also understood to mean an intensification of the effects of the transmitted movement on the body as an additional effect.

Moreover, the invention relates to the use of a neurophysiological stimulation device to stimulate the bodily functions of a living being, particularly for use in the fields of sports, rehabilitation, therapy, rapid regeneration, energy production, training, hyperactivity, skin tightening and tissue regeneration. Preferred areas of application for the claimed stimulation device are therefore: arthrosis, arthritis (joint inflammation), herniated disc (disc prolapse), burnout syndrome, cellulite, circulation problems, relaxation problems, joint pain, lumbago, sciatic pain (sciatica), headache (cephalalgia), varicose veins (varices), lumbar spine syndrome, lymphatic obstruction (lymphedema), loss of libido, Bekhterev's disease (ankylosing spondylitis), (neck) tension, nervousness, osteoporosis, Parkinson's disease, digestive problems, rheumatism, back pain, sleep disorders, stress, obesity and incontinence.

Overall, neurophysiological stimulation using a stimulation device in conjunction with a set-down device has the beneficial effects on the human psyche and physique described below:

The stimulation device according to the invention represents a biodynamic energy system that imitates the natural sequences of movements in the human body without the use of a stimulation current and/or chemical substances. The stimulation device does not produce unnatural “hard” movements, as occurs in most conventional vibrating plates. The coordinated, three-dimensional, rhythmic and vibration-free oscillation impulses of the stimulation device on the basis of the Schumann resonance frequency advantageously act holistically on a physical and psychological level. The importance to the human body of the Schumann resonance frequency, as the electromagnetic resonant frequency of the Earth, is known. The skeleton and the body itself are straightened, adjusted and rhythmized by the specific clockwise oscillation pattern of the stimulation device. The oscillations transmitted to the body in this way are holistic and versatile in their effect. Areas of application for the stimulation device include the fields of health, strengthening, flexibility, massage and relaxation as well as prevention, rehabilitation, therapy, comparative sports and cosmetic care.

According to the inventor, the effects achieved in the human body by the stimulation and transmission of motion produced by the claimed stimulation device are as follows:
Improving local and general mobility and muscular coordination,
Increasing muscle strength and performance,
Activating blood circulation and metabolic processes,
Relieving painful blockages and muscle tension,
Improving overall performance,
Strengthening the immune system,
Alleviating back pain and joint pain,
Reducing stress and insomnia,
Weight loss by activation of muscle mass and increased calorie consumption,
Mental and physical fitness

For the transmission of movement and vibrations from the stimulation device, there are several possibilities for how a person can be advantageously positioned on the movement unit. The appropriate positions depend on the regions of the body that are to be stimulated or the ailments and the particular application area. For example, the person can stand, lie or sit on the movement unit. Alternatively, the elbows, shoulders, hands, torso or feet, for example, can be specifically positioned on the movement unit. Here motion is transmitted holistically to the person by the one-piece movement unit; as an example, both of the arms positioned on the movement unit are moved together and uniformly. To enhance the transmitted movement and to provide additional stimulation, the set-down device according to the invention is arranged on the movement unit such that the person stands, sits or lies directly on the transmission side of the supporting unit. In an animal to be treated, such as a dog, a cat or a horse, the positioning on the moving unit occurs in a modified form. Nevertheless, sitting, standing and lying are generally feasible here, as well.

The invention will be described hereafter with reference to the embodiments illustrated in the drawings. Consistent reference signs will be used for identical or similar components or features. Features or components from different embodiments can be combined to obtain further embodiments. All features and/or advantages arising from the claims, description or drawings, including design details, spatial arrangement and method steps, can thus be essential to the invention both separately and in various combinations.

In the drawings:

FIG. 1 a schematic cross-sectional view of two adjacent stimulation elements,

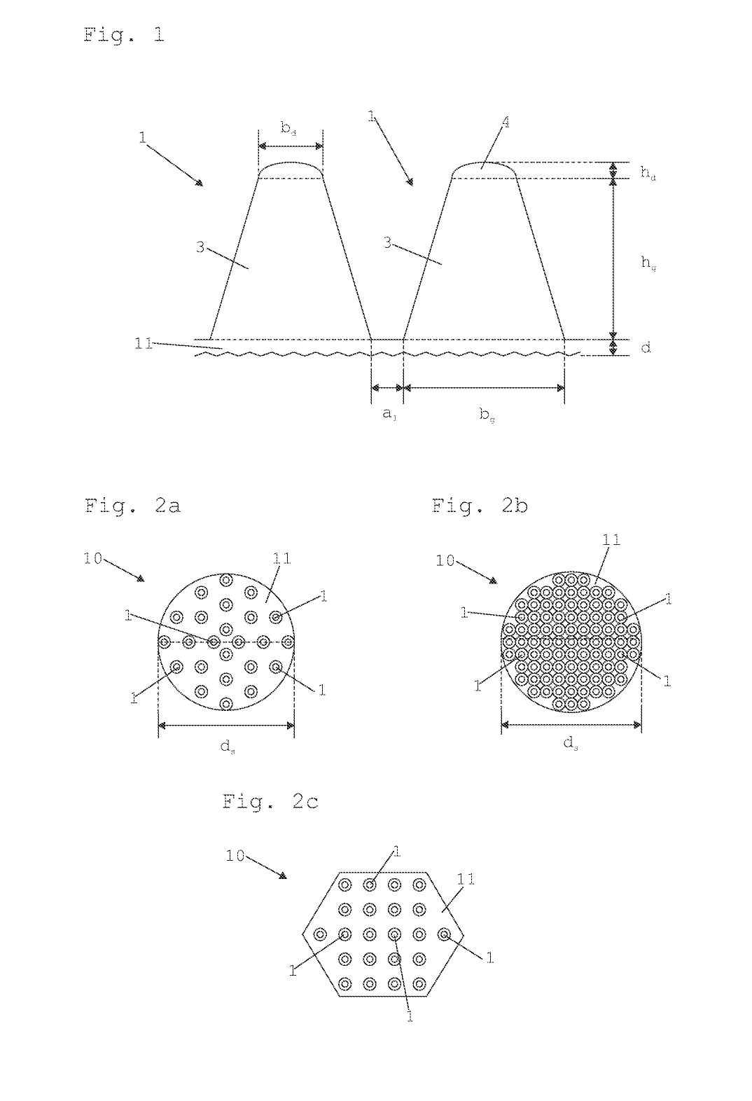

FIG. 2a-2b a schematic top view of a structural unit in various embodiments,

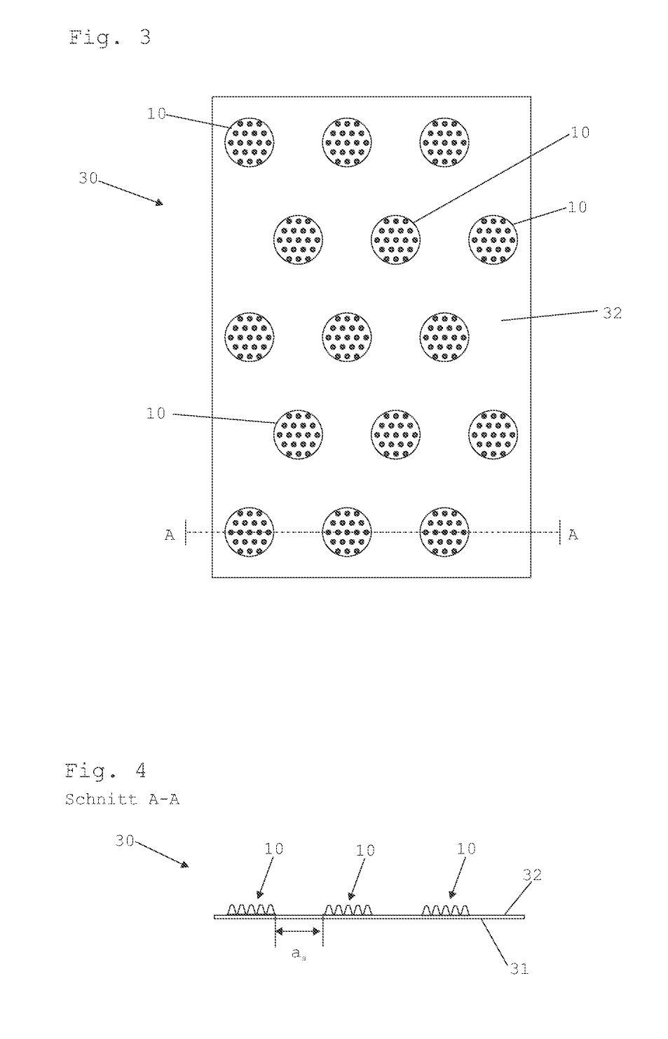

FIG. 3 a schematic top view of a set-down device,

FIG. 4 a schematic cross-sectional view along a section A-A of the set-down device according to FIG. 3, and

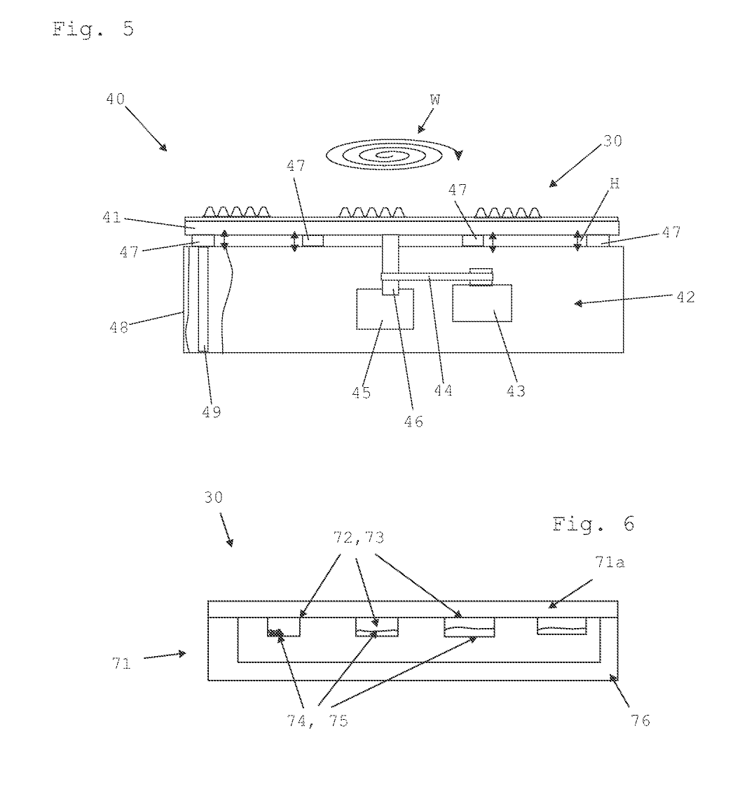

FIG. 5 a schematic cross-sectional view of a stimulation device with a set-down device according to FIG. 3 and

FIG. 6 a schematic cross-sectional view of another embodiment of a set-down device.

FIG. 1 shows a schematic cross-sectional view of two adjacent stimulation elements 1. According to the invention, said stimulation elements 1 serve to transmit movements and to provide neurophysiological stimulation. For the purpose of neurophysiological stimulation, the stimulation elements 1 are arranged in groups of multiple stimulation elements 1 in a structural unit (see FIG. 2a-2c). A plurality of these structural units, in turn, are arranged in a transmission pattern on a set-down device (see FIG. 3). A description of the structural units, the transmission pattern and the set-down device follows in the paragraphs regarding FIG. 2a-2c, 3 and 4. Accordingly, FIG. I shows a section of a structural unit with two adjacent stimulation elements.

The stimulation elements 1 are connected to each other by an undersurface II and are additionally connected, e.g. welded or adhered, to the set-down device, which is not shown here.

In this embodiment, the stimulation elements 1 and the undersurface 11 are configured in one piece, i.e. integrated. The under surf ace 11 has a thickness a of ca. 2 mm. The stimulation elements 1 are arranged at a distance a₁ of ca. 2 mm on the undersurface 11.

According to the embodiment in FIG. 1, the stimulation elements 1 are configured such that they taper away from the undersurface 11 and the set-down device, which is not shown here (see FIG. 4). For this reason, the stimulation elements 1 have a truncated cone shape. The truncated cone shape comprises a truncated conical base body 3 with a round cross-section and a levelled lid part 4 on the tapered side of the base body facing away from the undersurface 11. In this embodiment, the base body 3 has a height h_{g} of ca. 4 mm and the lid part 4 has a height h_{d} of ca. 0.5 mm. In total, the height of a truncated conical stimulation element 1 in this embodiment amounts to ca. 4.5 mm. The diameter or width b_{g} of the round base body 3 measures ca. 4 mm and the diameter or width b_{d} of the lid part 4 is ca. 1.5 mm, Suitable material for the stimulation elements 1 and the undersurface 11 is a plastic, for example, The stimulation elements 11 can be loaded with a weight of ca. 200 kg without deforming.

FIG. 2a-2c each show a schematic top view ox a structural unit in various embodiments. In each structural, unit 10, a plurality or a multitude of stimulation elements 1 are concentrated and are connected together by the undersurface 2, The undersurface 11 in these embodiments has a round, shape (see FIG. 2a and 2b) or a polygonal, i.e. honeycombed, shape (see FIG. 2c). The diameter d_{g} of the round structural units 10 (see FIG. 2a and 2b) measures ca. 30 mm. In this configuration, two adjacent stimulation elements 1 are arranged with spacing of up to 10 mm. According to the invention, the load capacity of multiple stimulation elements 1 that are arranged in one structural unit 1 is higher than the capacity of an individual stimulation element 1.

FIG. 3 and 4 show a schematic top view and a schematic cross-sectional view of a set-down device 30. The set-down device serves to provide support on a neurophysiological stimulation device (not shown here for the sake of overview), said neurophysiological stimulation device serving to stimulate an object, such as a human or an animal, by the transmission of movements generated by the stimulation device. The transmitted movements are enhanced by the set-down device 30.

The set-down device 30 has a support side 31 for supporting the set-down device 30 on the stimulation device. The set-down device 30 also has a transmission side 32 for transmitting and relaying the movements received by the support side 31 to the object. According to the embodiments in FIG. 3 and 4, the set-down device 30 is configured as a mat-like or cover-like set-down device 30 (see FIG. 4). The support side 31 and the transmission side 32 thus lie opposite one another, wherein, during a use situation, the support side 31 represents a lower side and the transmission side 32 represents an upper side. The stimulation elements 1 that taper away from the transmission side 32 and that are arranged in structural units 10 are disposed on the transmission side 32. Multiple stimulation elements 1 are arranged in each structural unit 10 and are connected together (see FIG. 2a), The structural units 10 are attached, e.g. adhered, to the transmission side 32. The structural units 10, in this case exactly 15 structural units 10, are arranged on the set-down device 30 in a transmission pattern 20. According to FIG. 3, the transmission pattern 20 is configured as a geometric pattern in the shape of honeycombs. In this way, the transmission pattern 20 provides for an even transmission and enhancement of the related movements.

FIG. 4 shows a section A-A through the set-down device 30 in the region of three structural units 10. In this embodiment and in this sectional plane, said structural units 10 are arranged at a distance a_{g} of ca. 40 mm from one another.

FIG. 5 shows a schematic cross-sectional view of a stimulation device 40 with a set-down device 30 according to FIG. 3. The stimulation device 40 serves to provide neurophysiological stimulation of a living being, such as a human or an animal, by the transmission of movements generated by the stimulation device 40. In so doing, primarily the therapeutic functions produced naturally in the body of the organism are activated. For the sake of overview, no living being is shown in the representation in FIG. 4. The stimulation device 40 comprises a movement unit 41 with a support surface, by means of which the generated movements are transmitted to objects adjacent to the movement unit. The movement unit 41 is configured in one piece, and so a closed or continuous support surface is formed. Moreover, the stimulation device 40 comprises a drive unit 42, which is coupled with the movement unit 41 to generate the movement. According to the invention, the drive unit 41 generates a wobbling and/or swiveling movement, which is indicated here by an arrow 11. This wobbling and/or swiveling movement is a three-dimensional oscillation with an open oscillation path, such as in the form of a clockwise or counterclockwise circular path. The oscillation is carried out, for example, at a frequency of 65-75 Hz.

In the embodiment according to FIG. 5, the drive unit 42 is configured as an eccentric drive unit 42, and so the movement unit 41 coupled with the drive unit 42 is moved eccentrically. For this purpose, the drive unit 42 comprises an eccentric pin 46 that is connected to the movement unit 41 and that, in turn, is coupled with an actuator, which itself generates the wobbling and/or swiveling movement. The actuator is designed in this embodiment as an electric motor 43 with a belt 44 to connect it to the pin. The pin 46 additionally comprises an eccentric bearing 45, The drive unit 42 is disposed in a cup-like housing 48 that is closed by the movement unit 41, which functions as a lid. The support surface of the movement unit 41 comprises a set-down device 30. The set-down device 30 corresponds to the embodiment in FIG. 3 and 4. End pieces 47 are arranged between the housing 48 and the movement unit 41 in order to prevent the moving movement unit 41 from recoiling onto the housing 48, for example.

It shall be understood that the aforementioned features of the invention can be used not only in the specified combination but also in other combinations or individually, without departing from the scope of the invention. FIG. 6 shows a schematic cross-sectional view of a different embodiment of a set-down device 30. The support mechanism 30 is configured as a cuboid plate 71. It comprises a lid 71a, under which are located hollow spaces 73 formed as blind holes 72, The hollow spaces 73 are filled to a percentage by volume with an oscillating mass in the form of a granulate 74. In addition, an outer enclosure 76 is provided. The support mechanism is made of anodized aluminum. The granulate 74 can have any desired granularity. Nevertheless, the granulate 74 is preferably a quartz granulate.

### LIST OF REFERENCE SIGNS

1 Stimulation element
2 Undersurface
3 Ease body
4 Lid part
10 Structural unit
11 Undersurface
20 Transmission pattern
30 Set-down device
31 Support side
32 Transmission side
410 Stimulation device
41 Movement unit
42 Drive unit
43 Motor
44 Belt
45 Bearing
46 (Eccentric) pin
47 End piece
48 Housing
49 Support
71 Plate
71a Lid
72 Blind hole
73 Hollow space
74 Granulate
75 Oscillating mass
76 Outer enclosure
a₁ Distance between two stimulation elements
a₂ Distance between two structural, units
b_{d} Width of the lid part
b_{g} Width of the base body
d thickness of the undersurface
d_{g} Diameter of a round structural unit.
h_{d} Height of the lid part
h_{g} Height of the base body
W Swiveling/wobbling movement

1-15. (canceled)

16. A set-down device for placement on a neurophysiological stimulation device to transmit movements generated by the stimulation device, at least comprising a support side for supporting the set-down device (30) on the stimulation device and a transmission side for transmitting and/or relaying the movements received by the support side, characterized in that
the set-down device is designed as a passive support mechanism configured in the form of a mat and/or plate, the transmission side having at least one at least partly protruding stimulation element that is suited to transmit the movements for neurophysiological stimulation.

17. The set-down device according to claim 16, characterized in that, at least one stimulation element is formed of a substantially inflexible material,

18. The set-down device according to claim 16, characterized in that the at least one stimulation element is configured as a stimulation element which tapers away from the transmission side.

19. The set-down device according to claim 16, characterized in that a plurality of stimulation elements are arranged in at least one structural unit to optimize transmission of the movements generated by the stimulation device.

20. The set-down device according to claim 16, characterized in that a plurality of structural units are arranged in a transmission pattern.

21. The set-down device according to claim 16, characterized in that the set-down device comprises at least one hollow space, with an oscillating mass being provided in at least one hollow chamber.

22. A stimulation device for stimulating an object by transmitting movements generated by the stimulation device, including a movement mechanism for stimulating therapeutic functions of a living being that occur naturally in a body, at least comprising a movement unit, which is configured to interact: with a set-down device and which has a support surface by means of which generated movements are transmitted to objects adjacent to the movement unit, and comprising at least one drive unit coupled to the movement unit to generate the movement, characterized in that
the drive unit rotates the movement unit eccentrically when in operation, and the movement unit rests on at least one support element when at rest and lifts from the support element at least temporarily during operation as a result of rotation caused by the drive unit, and so a three-dimensional wobbling and/or swiveling movement is produced.

23. The stimulation device according to claim 22, characterized in that the support surface comprises a set-down device as defined in claim 16.

24. The stimulation device according to claim 22, characterized in that the drive unit produces a three-dimensional oscillation with a frequency of 50-100 Hz, preferably 55-90 Hz, more preferably 60-80 Hz and most preferably 65-75 Hz, especially with a Schumann frequency.

25. The stimulation device according to claim 22, characterized in that the drive unit is configured as an eccentric drive unit.

26. The stimulation device according to claim 25, characterized in that the movement unit is set into circular or planar motion by the eccentric drive unit during operation, and support elements are provided on the edge of the movement unit, which alternatingly contact and do not contact the movement unit during operation so that the circular motion has a further direction of movement transversely to a circular path and the three-dimensional oscillation is realized in this way.

27. A neurophysiological stimulation device for stimulating an object by the transmission of movements generated by the stimulation device, including a movement mechanism for stimulating the therapeutic functions of a living being that occur naturally in a body, at least comprising a movement unit which has a support surface by means of which the generated movements are transmitted to objects adjacent to the movement unit, and comprising at least, one drive unit coupled to the movement unit to generate movement, characterized in that
the drive unit is configured as a wobbling and/or swiveling unit which generates a wobbling and/or swiveling movement, with a receptacle and/or support being provided for a set-down device as defined in claim 16.

28. The stimulation device according to claim 27, characterized in that the support surface comprises a set-down device as defined in claim 16.

29. The stimulation device according to claim 27, characterized in that the drive unit produces a three-dimensional oscillation with a frequency of 50-100 Hz, preferably 55-90 Hz, more preferably 60-80 Hz and most preferably 65-75 Hz, especially with a Schumann frequency.

30. The stimulation device according to claim 27, characterized in that the drive unit is configured as an eccentric drive unit

31. The stimulation device according to claim 30, characterized in that live movement unit is set into circular or planar motion by the eccentric drive unit during operation, and support elements are provided on the edge of the movement unit, which alternatingly contact and do not contact the movement unit during operation so that die circular motion has a further direction of movement transversely to a circular path and the three-dimensional oscillation is realized in this way.

32. A method for transmitting an oscillation to an object by means of a stimulation device as defined in claim 22, comprising the steps:
generating a movement and
transmitting the movement to the object, characterized in that
the movement is generated as a swiveling and/or wobbling movement and is
enhanced as it is transmitted.

33. The method according to claim 32, characterized in that, the transmission of the movement is enhanced by a set-down device as defined in claim 16.

34. A method for transmitting an oscillation to an object by means of a stimulation device as defined in claim 27, comprising the steps;
generating a movement and
transmitting the movement to the object, characterized in that
the movement is generated as a swiveling and/or wobbling movement and is
enhanced as it is transmitted.

35. The method according to claim 34, characterized in that the transmission of the movement is enhanced by a set-down device as defined in claim 16.
